(19) United States
(12) Patent Application Publication
(10) Pub. No.: US 2020/0276692 A1
(43) Pub. Date: Sep. 3, 2020

(54) FUEL-POWERED SETTING DEVICE AND METHOD FOR OPERATING SUCH A SETTING DEVICE

(71) Applicant: Hilti Aktiengesellschaft

(72) Inventors: Iwan WOLF, Untervaz (CH); Dominik SCHMIDT, Buchs (CH); Tilo DITTRICH, Feldkirch (AT); Peter BRUGGMUELLER, Bludesch (AT); Norbert HEEB, Buchs (CH)

(21) Appl. No.: 16/063,818

(22) PCT Filed: Dec. 20, 2016
(86) PCT No.: PCT/EP2016/081902

§ 371 Date: Jun. 19, 2018

(30) Foreign Application Priority Data
Dec. 22, 2015 (EP) 15201867.7

(51) Int. Cl. B25C 1/08; F02B 19/10; F02B 19/18; F02B 63/02

(52) U.S. Cl. CPC B25C 1/08; F02B 63/02; F02B 19/18; F02B 19/1023

(57) ABSTRACT

The invention relates to a fuel-powered setting device for driving securing elements into a substrate, comprising at least one main combustion chamber for a fuel, a drive piston that can be driven out of the main combustion chamber in a setting direction by means of expandable gases, and a prechamber with which an ignition arrangement is associated and in which a pressure acting on the main combustion chamber can build up prior to a fuel-air mixture being ignited in said main combustion chamber, wherein the prechamber is or can be connected to surroundings of the prechamber via at least one passage opening able to be closed by a control device. To improve efficiency and/or functionality when driving in securing elements, the control device and the main combustion chamber are linked by a control pressure connection.

### TECHNICAL FIELD

The present invention relates to a combustion-powered setting tool for driving fastening elements into a substrate, having at least one main combustion chamber for a fuel, having a drive piston actuatable by way of expandable gases from the main combustion chamber in the setting direction, and having a prechamber, to which an ignition device is assigned and in which a pressure acting on the main combustion chamber is buildable prior to the ignition of a fuel-air mixture in the main combustion chamber, the prechamber being connected or connectable to the surroundings of the prechamber by at least one passage opening, which is closeable by a control device. The present invention further relates to a method for operating such a combustion-powered setting tool.

### BACKGROUND OF THE INVENTION

German patent publication DE 10 32 035 A1 discloses a combustion-powered setting tool for driving fastening elements into a substrate, which has at least one main combustion chamber for a fuel, one drive piston mounted in a piston guide actuatable in the setting direction by way of expandable gases from the main combustion chamber, and which has a prechamber, in which a pressure acting on the main combustion chamber is buildable prior to the ignition of a fuel-air mixture in the main combustion chamber, the prechamber being formed within the piston guide by a space connecting to the bottom side of the drive piston being in its initial position and facing away from the main combustion chamber, and the prechamber at least temporarily being connected via a passage opening to the main combustion chamber, and in the main combustion chamber a means for detecting the pressure being provided, which acts together with the ignition device for the main combustion chamber.

### SUMMARY OF THE INVENTION

The object of the present invention is to improve the effectiveness and/or functionality when in-driving fastening elements using a combustion-powered setting tool, having at least one main combustion chamber for a fuel, having a drive piston actuatable by way of expandable gases from the main combustion chamber in the setting direction, and having a prechamber, to which an ignition device is assigned and in which a pressure acting on the main combustion chamber is buildable prior to the ignition of a fuel-air mixture in the main combustion chamber, the prechamber being connected or connectable to the surroundings of the prechamber by at least one passage opening, which is closeable by a control device.

The object of the present invention for a combustion-powered setting tool for driving fastening elements into a substrate, having at least one main combustion chamber for a fuel, having a drive piston actuatable by way of expandable gases from the main combustion chamber in the setting direction, and having a prechamber, to which an ignition device is assigned and in which a pressure acting on the main combustion chamber is buildable prior to the ignition of a fuel-air mixture in the main combustion chamber, the prechamber being connected or connectable to the surroundings of the prechamber by at least one passage opening, which is closeable by a control device, is achieved in that the control device is connected to the main combustion chamber by control pressure. By way of the control pressure connection, the control device is actuated by the main combustion chamber pressure during operation of the setting tool. After the pressure in the main combustion chamber has reached a certain pressure level, at least one passage opening of the passage opening is then automatically opened. The control pressure connection may be implemented in different ways.

A preferred exemplary embodiment of the combustion-powered setting tool is characterized by the fact that the control device has at least one control pressure surface which is applied with the main combustion chamber pressure. This has the advantage that no additional sensor device is needed to detect the main combustion chamber pressure.

Moreover, the main combustion chamber pressure acting on the control pressure surface may be directly used, for example via a suitable mechanical coupling, to control or affect the opening or the releasing and closing of the passage opening of the prechamber.

A further preferred exemplary embodiment of the combustion-powered setting tool is characterized by the fact that the control pressure surface of the control device is mechanically coupled to a control sleeve. For example, the control sleeve substantially has the shape of a circular cylinder jacket, which relative to a housing or a cylinder delimiting the prechamber is moveable between an open position, in which the passage opening is released or open, and a closed position, in which the passage opening of the prechamber is released.

A further preferred exemplary embodiment of the combustion-powered setting tool is characterized by the fact that the control sleeve is configured in such a manner that and is moveable in relation to the passage opening of the prechamber so that the passage opening of the prechamber is released or closed by the control sleeve as a function of the main combustion chamber pressure. The movement of the control sleeve advantageously is controlled by the main combustion chamber pressure acting on the control pressure surface. For example, the movement of the control sleeve between the open position and the closed position is enabled by guiding the control sleeve at the housing or the cylinder delimiting the prechamber.

A further preferred exemplary embodiment of the combustion-powered setting tool is characterized by the fact that the control pressure surface of the control device is mechanically coupled to the control sleeve via a coupling element. The coupling element may be a slider, for example. Advantageously, the control pressure surface is formed at an end of the slider facing the main combustion chamber. Advantageously, the slider is coupled to the control sleeve at an end of the slider facing away from the main combustion chamber. Advantageously, the slider serves to transfer a pressure force generated by the main combustion chamber pressure acting on the control sleeve surface to the control sleeve.

A further preferred exemplary embodiment of the combustion-powered setting tool is characterized by the fact that the control pressure surface is braced by at least one spring device at a stop fixedly joined with the housing. The stop fixedly joined with the housing, for example, is attached in the housing or the cylinder delimiting the prechamber. The spring device pretensions the control pressure surface, in particular in combination with the control sleeve, into the closed position, in which the passage opening of the prechamber is closed by the control sleeve.

A further preferred exemplary embodiment of the combustion-powered setting tool is characterized by the fact that the control pressure surface is configured as an annular surface and is situated radially outside of a piston guide space. The drive piston is guided moveably back and forth in the piston guide space. In this instance, the drive piston can be guided directly in the piston guide space. It is however also possible to guide a piston rod or a piston plunger of the drive piston in an additional piston guide within the piston guide space. Depending on the configuration, the piston guide space coincides with the prechamber.

A further preferred exemplary embodiment of the combustion-powered setting tool is characterized by the fact that a further ignition device is assigned to the main combustion chamber. The previously described setting tool can only be operated by an ignition device which is assigned to the prechamber. Following an ignition in the prechamber, the reaction gases from the prechamber expand into the main combustion chamber having a spreading flame front. Via the flame front spreading into the main combustion chamber, the ignition of a pre-compressed fuel-air mixture included in the main combustion chamber then occurs in the main combustion chamber. The ignition of the fuel-air mixture in the main combustion chamber may however also take place via the further ignition device in the main combustion chamber.

In a method for operating a combustion-powered setting tool described previously, the above indicated object is alternatively or additionally achieved in that the control of the passage opening of the prechamber is carried out by the main combustion chamber pressure. In so doing, a combustion-powered or gas-powered setting tool, which has a substantially higher energy density, can be implemented in a simple manner. The previously described measures enable to control a ventilation of the prechamber in a particularly simple manner. For this purpose, an undesireable wear of the setting tool when in use may be reduced. Moreover, controlling the passage opening of the prechamber by the main combustion chamber pressure can ensure a significantly increased service life of the setting tool.

The present invention further relates to a control device, in particular a control sleeve and/or a coupling element, for a previously described setting tool. The mentioned parts are optionally separately negotiable.

Further advantages, features and details of the present invention result from the subsequent description, in which different exemplary embodiments are described in greater detail on the basis of the drawing.

In the figures,

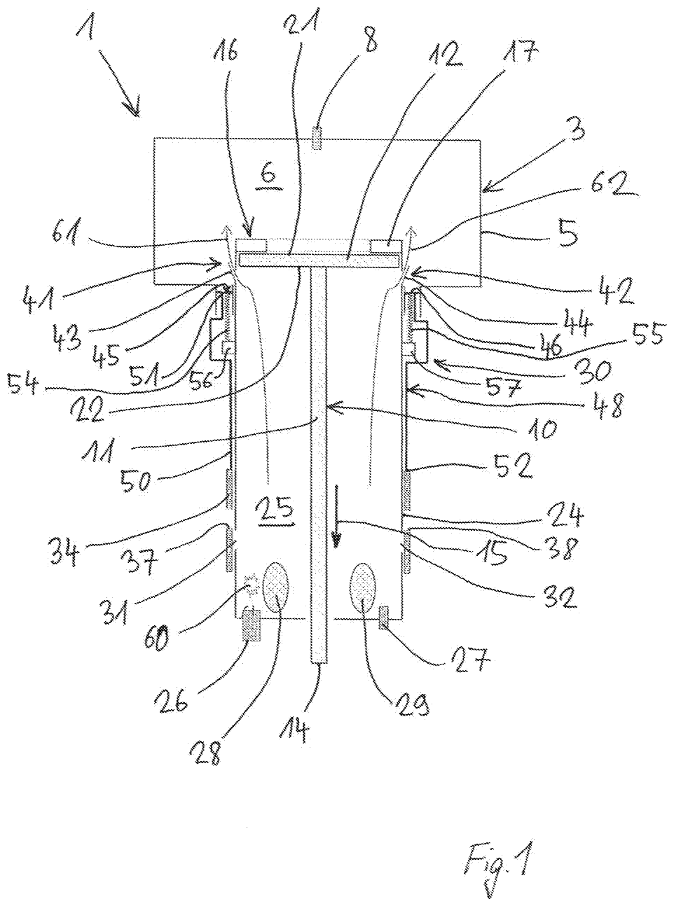

FIG. 1 shows a longitudinal section of a simplified illustration of a combustion-powered setting tool including a control device after an ignition in a prechamber;

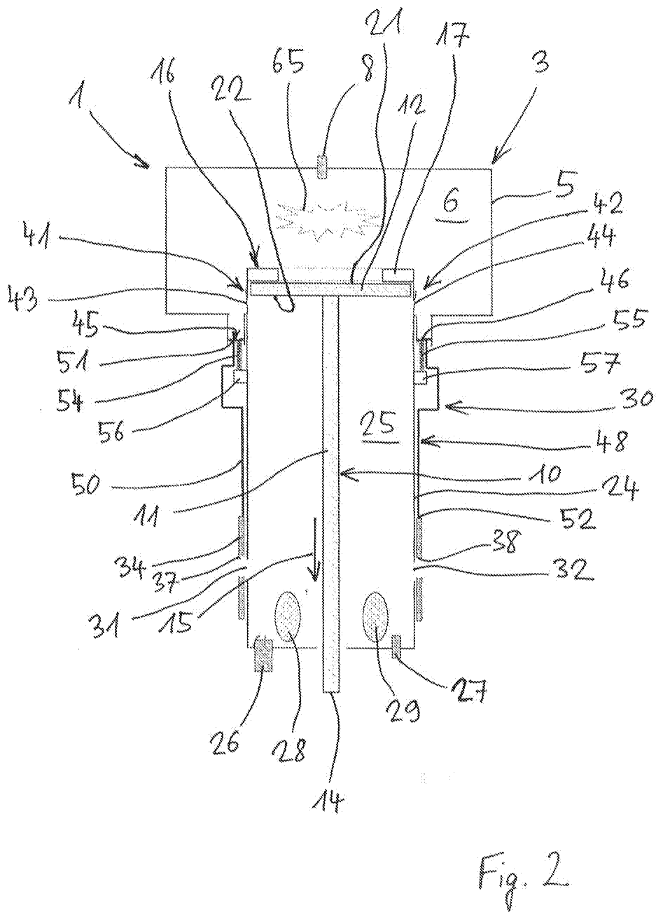

FIG. 2 shows the setting tool from FIG. 1 shortly after an ignition in the main combustion chamber;

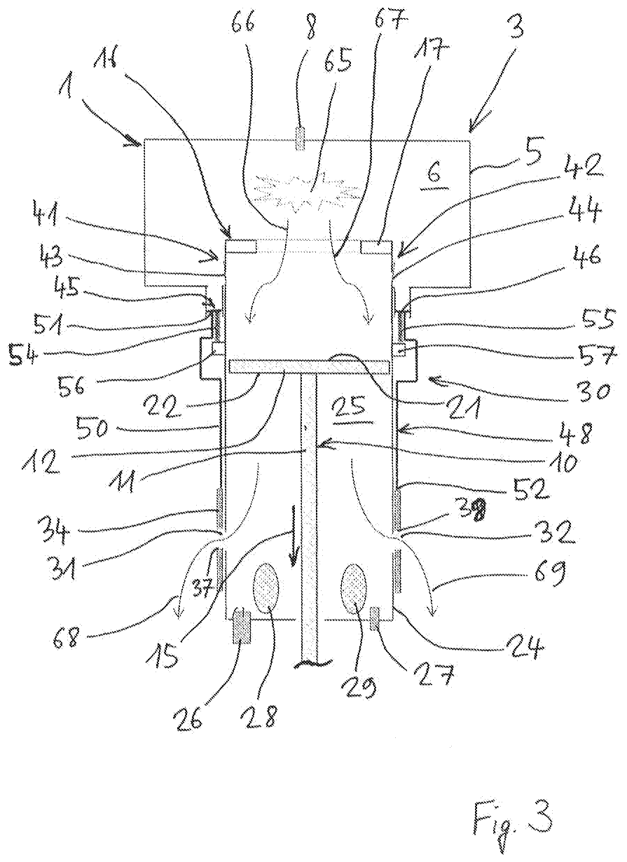

FIG. 3 shows the setting tool from FIGS. 1 and 2 shortly after the ignition in the main combustion chamber having open passage openings of the prechamber for ventilation;

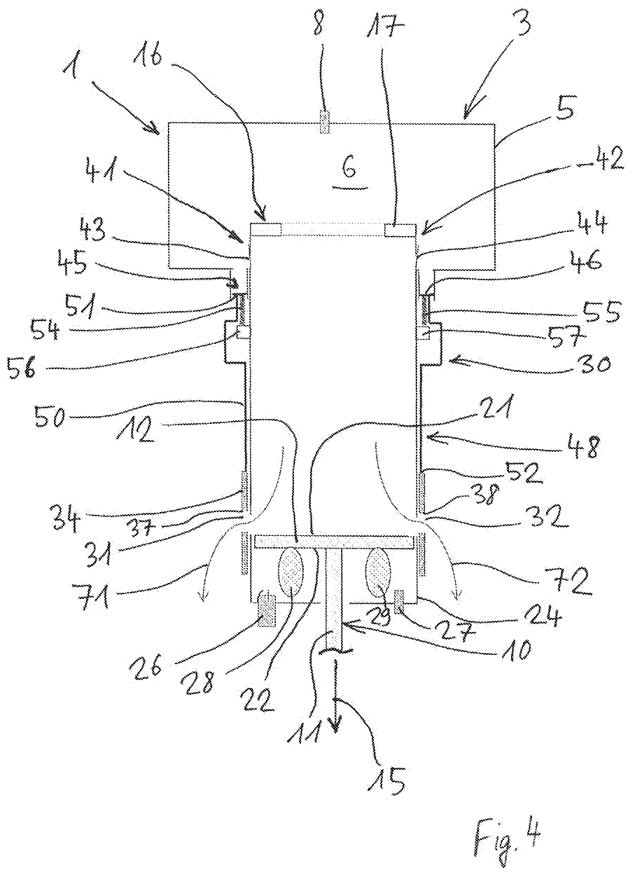

FIG. 4 shows the setting tool from FIGS. 1 through 3 having a drive piston in a bottom dead center;

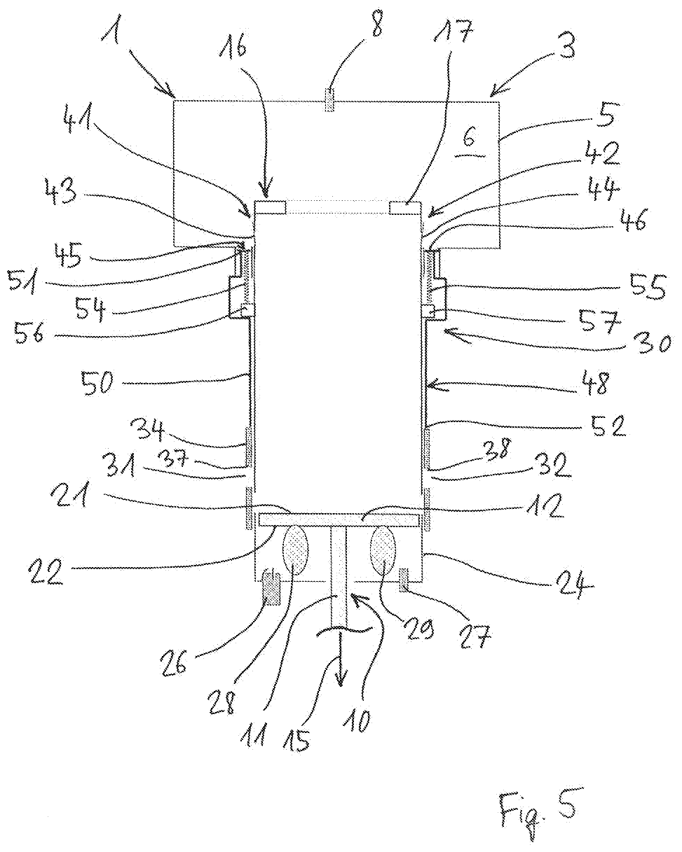

FIG. 5 shows the setting tool from FIGS. 1 through 4 having a drive piston in the bottom dead center having a closed control sleeve;

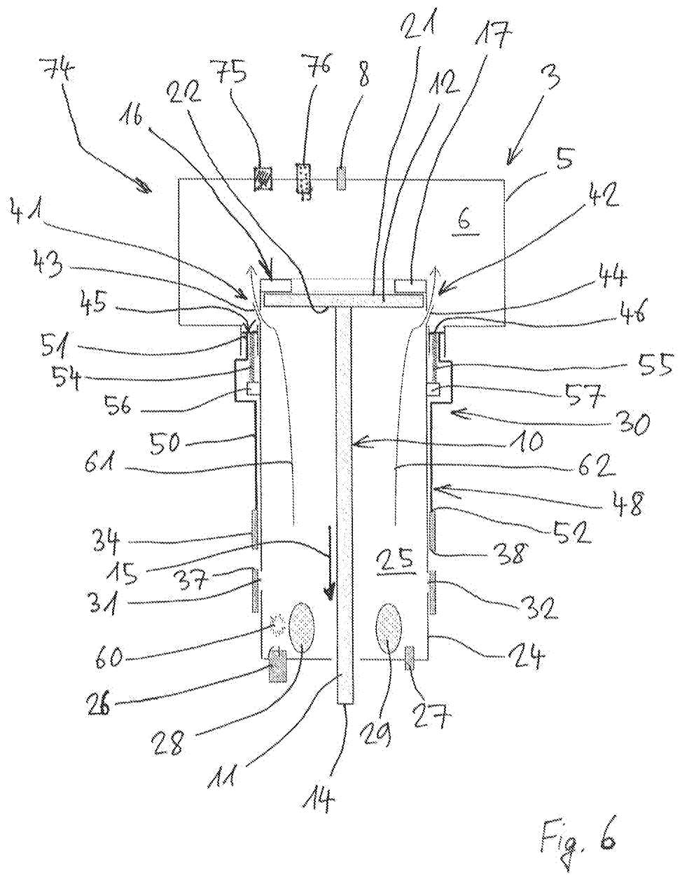

FIG. 6 shows the setting tool from FIG. 1 according to a further exemplary embodiment having a further ignition device, which is assigned to the main combustion chamber; and

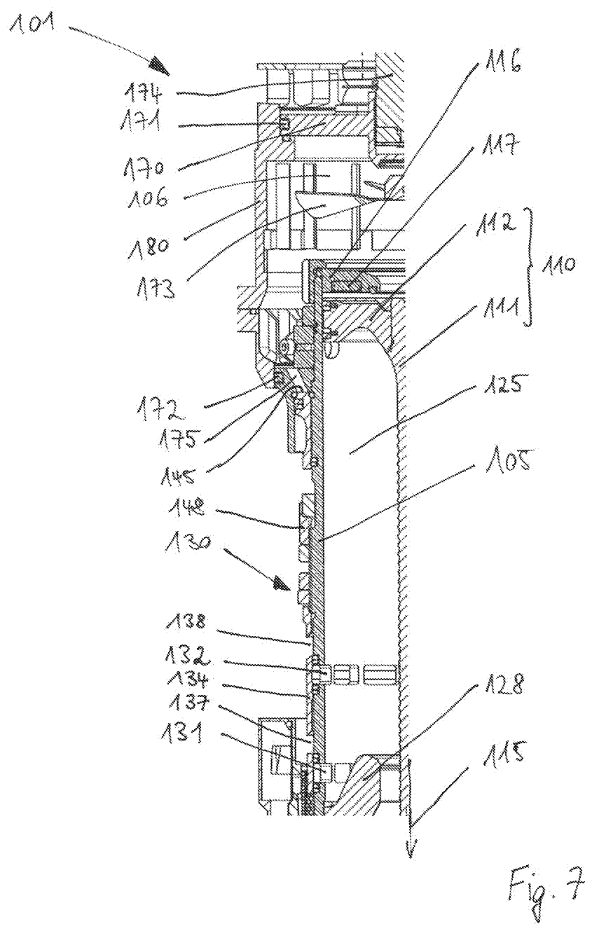

FIG. 7 shows partially a longitudinal section of a combustion-powered setting tool having a control device after an ignition in a prechamber.

### EXEMPLARY EMBODIMENTS

FIGS. 1 through 5 show a setting tool 1 in a greatly simplified manner in a longitudinal section in different operating states. Setting tool 1 illustrated in FIGS. 1 through 5 can be operated by a combustion gas or by a vaporizable liquid fuel. Setting tool 1 includes a housing 3 having a main cylinder 5, which delimits a main combustion chamber 6. Gas and/or air can be supplied to main combustion chamber 6 via an inlet device 8.

In FIGS. 1 through 5, a drive piston 10 is guided moveably back and forth in the downward and upward directions in housing 3 of setting tool 1. Drive piston 10 includes a piston rod 11, which emanates from a piston head 12. A setting end 14 of piston rod 11 facing away from piston head 12 is situated in a bolt guide (not shown), which serves the purpose of guiding fastening elements also referred to as bolts. In FIGS. 3, 4, 5, setting end 14 of piston rod 11 of drive piston 10 is shown in a cut-off manner.

The bolt guide including piston rod 11 of drive piston 10 situated therein is also referred to as a setting mechanism. Via the setting mechanism, a fastening element such as a nail, bolt or the like can be driven into a substrate (not shown). Before setting the fastening element, setting tool 1 is pressed by its bolt guide against the substrate, and is triggered. For example, a switch (not shown), which is also referred to as a trigger switch, serves to trigger a setting procedure. The switch, for example, is provided at a handlebar (also not shown) of setting tool 1.

In FIGS. 1 through 5, a setting direction is indicated by an arrow 15. When setting the fastening elements, drive piston 10 is greatly accelerated by piston rod 11 in setting direction 15 to drive the fastening element into the substrate. During the setting procedure, drive piston 10 is moved from its initial position shown in FIG. 1, which corresponds to a top dead center, into an end position, which is shown in FIG. 4, for example, and corresponds to a bottom dead center.

A movement of drive piston 10, in the upward direction in FIGS. 1 through 5, is limited by a piston stop 16 fixedly joined with the housing. Piston stop 16 defines the top dead center of drive piston 10. Piston stop 16 may be combined with a magnetic device 17. Magnetic device 17, for example, serves to keep drive piston 10 by a predetermined holding force in its initial position shown in FIG. 1. A movement of drive piston 10 in the downward direction is limited by stop and/or damping elements 28, 29. Stop and/or damping elements 28, 29 are configured as a buffer, for example.

Piston head 12 includes a first piston surface 21, which is facing main combustion chamber 6. A second piston surface 22, which is facing away from main combustion chamber 6, delimits a prechamber 25 in a prechamber cylinder 24. Prechamber cylinder 24 is part of housing 3 of setting tool 1 or is rigidly connected to housing 3.

Prechamber 25 represents a pre-combustion chamber, to which an ignition device 26 and an inlet device 27 are assigned. Moreover, stop and/or damping elements 28, 29 are situated in prechamber 25. Via inlet device 27, a fuel-air mixture is supplied to prechamber or pre-combustion chamber 25, which is ignited in prechamber 25 with the aid of ignition device 26, such as it is indicated in FIG. 1 by a symbol 60.

Prechamber cylinder 24 includes two passage openings 31, 32, which, for example, enable the discharge of exhaust gases from prechamber 25. Passage openings 31, 32 are closeable on demand by a control device 30. Control device 30 includes a control sleeve 34, which has two passage openings 37, 38. If passage openings 37, 38 of control sleeve 34 are positioned to overlap with passage openings 31, 32, then passage openings 31, 32 are open, as can be seen in FIGS. 2, 3, 4. In FIGS. 1 and 5, passage openings 31, 32 are closed by control sleeve 34. Control sleeve 34 substantially has the shape of a straight circular cylinder jacket and in FIGS. 1 through 5 is moveable in the upward and downward directions.

Two overflow openings 41, 42 are provided between prechamber 25 and main combustion chamber 6. Respectively one valve device 43, 44 is assigned to overflow opening 41, 42. Valve devices 43, 44, for example, may be valve flaps, which are open in FIG. 1, to enable that the fuel-air mixture passes from prechamber 25 into main combustion chamber 6. In FIGS. 2 and 5, valve devices 43, 44 are closed.

Control device 30 includes a control pressure surface 45, which is connected in terms of control pressure to main combustion chamber 6. Control pressure surface 45 is configured as annular surface 46, which is facing main combustion chamber 6 radially outside of prechamber cylinder 24. Control pressure surface 45 is mechanically coupled via a coupling element 48 to control sleeve 34. Coupling element 48 is configured as slider 50, which in FIGS. 1 through 5 is guided moveably back and forth in the upward and downward directions at prechamber cylinder 24. At an upper end 51 of slider 50 in FIGS. 1 through 5, a control pressure surface 45 configured as annular surface 46 is provided. Control sleeve 34 is attached at a lower end 52 of slider 50 in FIGS. 1 through 5.

Control device 30 further includes spring devices 54, 55, which are designed as helical compression springs, for example. Respectively one stop 56, 57, fixedly joined with the housing in FIGS. 1 through 5, is assigned to the lower end of spring devices 54, 55. Stops 56, 57 fixedly joined with the housing are provided at prechamber cylinder 24. Spring devices 54, 55 together with control pressure surface 45 are clamped between stops 56, 57 fixedly joined with the housing and upper end 51 of slider 50. In so doing, slider 50 is braced at stops 56, 57 fixedly joined with the housing via spring devices 54, 55.

In FIG. 1, setting tool 1 is shown shortly after ignition 60 in prechamber 25. Arrows 61, 62 indicate that the ignited mixture enters main combustion chamber 6 via open valve devices 43, 44 through overflow openings 41, 42. Passage openings 31, 32 of prechamber 25 are closed by control sleeve 34.

In FIG. 2, setting tool 1 is shown shortly after ignition in main combustion chamber 6. The ignition in main combustion chamber 6 is indicated by a symbol 65. Ignition 65 in main combustion chamber 6, for example, is triggered via a flame front from prechamber 25 (not shown). The increased pressure in main combustion chamber 6 closes valve devices 43, 44. At the same time, control device 30 opens passage openings 31, 32 so that exhaust gas can escape from prechamber 25.

The release of passage openings 31, 32 of prechamber 25 by control sleeve 34 is triggered by the increased pressure in main combustion chamber 6, which acts on control pressure surface 45 and which is transferred via the slider 50 to control sleeve 34. By the movement of control sleeve 34 in the downward direction in FIG. 2, passage openings 37, 38 of control sleeve 34 are positioned to overlap with passage openings 31, 32 in prechamber cylinder 24.

In FIG. 3, setting tool 1 is shown shortly after ignition 65 in main combustion chamber 6. Main combustion chamber 6 is also referred to shortly as main chamber 6. In FIG. 3, arrows 66 and 67 indicate that the increased pressure in or from main combustion chamber 6 acts on first piston surface 21 of drive piston 10 facing main combustion chamber 6, as a result of which the drive piston in FIG. 3 is moved downwards in setting direction 15. Arrows 68 and 69 indicate that when drive piston 10 is moved downwards in setting direction 15, exhaust gas from prechamber 25 discharges through open passage openings 31, 32.

In FIG. 4, drive piston 10 is shown in its bottom dead center. Piston head 12 of drive piston 10 comes into contact with stop and/or damping elements 28, 29. In the bottom dead center, piston head 12 of drive piston 10 in FIG. 4 is situated below open passage openings 31, 32 of prechamber 25. Arrows 71, 72 indicate that exhaust gases or hot gases escape from main combustion chamber 6 via open passage openings 31, 32.

In FIG. 5, drive piston 10 is still located in its bottom dead center. When the hot gases escape, the pressure of main combustion chamber or main chamber 6 decreases. The decreasing pressure in main combustion chamber 6 together with the spring force of spring devices 54, 55 of control device 30 affects that control sleeve 34 closes passage openings 31, 32 in prechamber cylinder 24. The return of drive piston 10 subsequently takes place thermically (not shown) by the cooling of the hot gases in main combustion chamber 6, a vacuum resulting in the main combustion chamber.

Such as illustrated in FIGS. 1 through 5, FIG. 6 shows a similar combustion-powered setting tool 74. Setting tool 74 differs from setting tool 1 illustrated in FIGS. 1 through 5 in that additionally a valve device 75 and also a further ignition device 76 are assigned to main combustion chamber 6.

Valve device 75 enables a ventilation of main combustion chamber 6, for example for flushing purposes. Via further ignition device 76, a gas mixture can be ignited in main combustion chamber 6 independent from whether an ignition has been already taken place in prechamber 25. In so doing, further operating modes of setting tool 74 become possible. Otherwise, setting tool 74 in FIG. 6 does not differ from setting tool 1 shown in FIGS. 1 through 5.

As a further exemplary embodiment, FIG. 7 partially shows a setting tool 101 operated by a combustion gas or by a vaporizable liquid fuel. Setting tool 101 includes a main cylinder 105 rigidly connected to different elements, which is illustrated by the same hatching as main cylinder 105. In main cylinder 105, a drive piston 110 is guided moveably back and forth downwards and upwards in setting direction 115. Drive piston 110 includes a piston rod 111, which emanates from a piston head 112.

When setting a fastening element, drive piston 110 is greatly accelerated in setting direction 115 by piston rod 111, starting from the initial position shown in FIG. 7, to drive a not shown fastening element into an also not shown substrate. A movement of drive piston 110 in the downward direction is dampened by buffer 128. A piston stop 116 for upwardly delimiting drive piston 110 has a magnetic device 117, which keeps drive piston 110 by a predetermined holding force in its initial position illustrated in FIG. 7.

A main combustion chamber 106 is substantially delimited by piston head 112 (in setting direction 115), by a back-wall plate 170 (against setting direction 115) and by combustion chamber sleeve 180 (transverse to setting direction 115). Main combustion chamber 106 can be flushed with fresh air by displacing combustion chamber sleeve 180 vis-a-vis main cylinder 105 and back wall plate 170 in setting direction 115. FIG. 7 shows a closed position of combustion chamber sleeve 180, in which the annular flushing openings are closed and are sealed with the aid of sealing rings 171, 172. A ventilator 173 actuated by a ventilation motor 174 serves fresh air purging and a swirling or generating of turbulence within main combustion chamber 106.

A prechamber 125 is substantially delimited by piston head 112 (against setting direction 115), by a not shown end face of main cylinder 105 (in setting direction 115) and by main cylinder 105 (transverse to setting direction 115). Prechamber 125 represents a pre-combustion chamber, to which a not shown ignition device and an also not shown inlet device for fuel are assigned. Moreover, the buffer is situated in prechamber 125.

Main cylinder 105 includes two passage openings 131, 132, which, for example, enable the discharge of exhaust gases from prechamber 125. Passage openings 131, 132 are closeable on demand by a control device 130. Control device 130 includes a control sleeve 134, which has two passage openings 137, 138. If passage openings 137, 138 of control sleeve 134 are positioned to overlap with passage openings 131, 132, then passage openings 131, 132 are open. In FIG. 7, passage openings 131, 132 are closed by control sleeve 134. Control sleeve 134 substantially has the shape of a straight circular cylinder jacket and in FIG. 7 is moveable in the upward and downward directions.

Two not shown overflow openings provided with valve devices are provided between prechamber 125 and main combustion chamber 106 to enable a passage of the ignited fuel-air mixture from prechamber 125 into main combustion chamber 106.

Control device 130 includes a control pressure surface 145, which is connected in terms of control pressure to main combustion chamber 106. Control pressure surface 145 is configured as an annular surface, which with the aid of one or a plurality of borings 175 in main cylinder 105 is facing main combustion chamber 106 within main cylinder 105, and which is exposed to a vacuum in main combustion chamber 106. Control pressure surface 145 via a coupling element 148 is mechanically coupled, in particular rigidly coupled, to control sleeve 134. Control pressure surface 145 and borings 175 are situated radially inside of the combustion chamber sleeve and, in particular, of sealing ring 171.

Control device 30 further includes not shown spring devices for pretensioning control sleeve 134 and control pressure surface 145 into the respective position shown in FIG. 7.

The mode of operation of control device 130 corresponds substantially with the mode of operation of control device 30 of the first exemplary embodiment (FIGS. 1 through 5).

1. A combustion-powered setting tool for driving fastening elements into a substrate, comprising at least one main combustion chamber for a fuel; a drive piston actuatable by expandable gases from the at least one main combustion chamber in a setting direction; and a prechamber, to which an ignition device is assigned and in which a pressure acting on the at least one main combustion chamber is buildable prior to ignition of a fuel-air mixture in the at least one main combustion chamber, wherein the prechamber is connected or connectable to surroundings of the prechamber by at least one passage opening, which is closeable by a control device, wherein the control device is connected to the at least one main combustion chamber to control main combustion chamber pressure.

2. The combustion-powered setting tool as recited in claim 1, wherein the control device has at least one control pressure surface, which is acted on by the at least one main combustion chamber pressure.

3. The combustion-powered setting tool as recited in claim 2, wherein the at least one control pressure surface of the control device is mechanically coupled to a control sleeve.

4. The combustion-powered setting tool as recited in claim 3, wherein the control sleeve is configured to be moveable in relation to the at least one passage opening of the prechamber so that the at least one passage opening of the prechamber is released or closed by the control sleeve as a function of the at least one main combustion chamber pressure.

5. The combustion-powered setting tool as recited in characterized claim 3, wherein the at least one control pressure surface is mechanically coupled to the control sleeve via a coupling element.

6. The combustion-powered setting tool as recited in claim 2, wherein the tool comprises a housing and the at least one control pressure surface is braced by at least one spring device at a stop fixedly joined with the housing.

7. The combustion-powered setting tool as recited in claim 2, wherein the at least one control pressure surface is configured as an annular surface and is situated radially outside of a piston guide space.

8. The combustion-powered setting tool as recited in claim 1, wherein a further ignition device is assigned to the at least one main combustion chamber.

9. A method for operating a combustion-powered setting tool as recited in claim 1, the method comprising controlling the passage opening of the prechamber by the at least one main combustion chamber pressure.

10. A control device, comprising a control sleeve and/or a coupling element for a setting tool.

11. The combustion-powered setting tool as recited in claim 4, wherein the at least one control pressure surface is mechanically coupled to the control sleeve via a coupling element.

12. The combustion-powered setting tool as recited in claim 3, wherein the tool comprises a housing and the at least one control pressure surface is braced by at least one spring device at a stop fixedly joined with the housing.

13. The combustion-powered setting tool as recited in claim 4, wherein the tool comprises a housing and the at least one control pressure surface is braced by at least one spring device at a stop fixedly joined with the housing.

14. The combustion-powered setting tool as recited in claim 5, wherein the tool comprises a housing and the at least one control pressure surface is braced by at least one spring device at a stop fixedly joined with the housing.

15. The combustion-powered setting tool as recited in claim 11, wherein the tool comprises a housing and the at least one control pressure surface is braced by at least one spring device at a stop fixedly joined with the housing.

16. The combustion-powered setting tool as recited in claim 12, wherein the tool comprises a housing and the at least one control pressure surface is braced by at least one spring device at a stop fixedly joined with the housing.

17. The combustion-powered setting tool as recited in claim 3, wherein the at least one control pressure surface is configured as an annular surface and is situated radially outside of a piston guide space.

18. The combustion-powered setting tool as recited in claim 4, wherein the at least one control pressure surface is configured as an annular surface and is situated radially outside of a piston guide space.

19. The combustion-powered setting tool as recited in claim 5, wherein the at least one control pressure surface is configured as an annular surface and is situated radially outside of a piston guide space.

20. The combustion-powered setting tool as recited in claim 6, wherein the at least one control pressure surface is configured as an annular surface and is situated radially outside of a piston guide space.
